(19) United States
(12) Patent Application Publication
(10) Pub. No.: US 2023/0209003 A1
(43) Pub. Date: Jun. 29, 2023

(54) VIRTUAL PRODUCTION SETS FOR VIDEO CONTENT CREATION

(71) Applicant: AT&T Intellectual Property I, L.P., Atlanta, GA (US)

(72) Inventors: Eric Zavesky, Austin, TX (US); Tan Xu, Bridgewater, NJ (US); Zhengyi Zhou, Chappaqua, NY (US)

(21) Appl. No.: 17/646,224

(22) Filed: Dec. 28, 2021

(51) Int. Cl. H04N 5/222; G06T 17/00; G06T 19/00; G06T 7/194; G06T 19/20

(52) U.S. Cl. CPC H04N 5/2224; G06T 7/194; G06T 17/00; G06T 19/006; G06T 19/20; G06T 2200/24; G06T 2207/10016; G06T 2219/2024

(57) ABSTRACT

In one example, a method performed by a processing system including at least one processor includes identifying a background for a scene of video content, generating a three-dimensional model and visual effects for an object appearing in the background for the scene of video content, displaying a three-dimensional simulation of the background for the scene of video content, including the three-dimensional model and visual effects for the object, modifying the three-dimensional simulation of the background for the scene of video content based on user feedback, capturing video footage of a live action subject appearing together with the background for the scene of video content, where the live action subject appearing together with the background for the scene of video content creates the scene of video content, and saving the scene of video content.

The present disclosure relates generally to the creation of video content, and relates more particularly to devices, non-transitory computer-readable media, and methods for building virtual production sets for video content creation.

### BACKGROUND

Augmented reality (AR) applications are providing new ways for expert and novice creators to create content. For instance, one virtual production method comprises mixed reality (MR) with light emitting diodes (LEDs). MR with LEDs allows content creators to place real world characters and objects in a virtual environment, by integrating live action video production with a virtual background projected on a wall of LEDs. The virtual background images then move relative to the tracked camera to present the illusion of a realistic scene.

### SUMMARY

In one example, the present disclosure describes a device, computer-readable medium, and method for building virtual production sets for video content creation. For instance, in one example, a method performed by a processing system including at least one processor includes identifying a background for a scene of video content, generating a three-dimensional model and visual effects for an object appearing in the background for the scene of video content, displaying a three-dimensional simulation of the background for the scene of video content, including the three-dimensional model and visual effects for the object, modifying the three-dimensional simulation of the background for the scene of video content based on user feedback, capturing video footage of a live action subject appearing together with the background for the scene of video content, where the live action subject appearing together with the background for the scene of video content creates the scene of video content, and saving the scene of video content.

In another example, a non-transitory computer-readable medium stores instructions which, when executed by a processing system, including at least one processor, cause the processing system to perform operations. The operations include identifying a background for a scene of video content, generating a three-dimensional model and visual effects for an object appearing in the background for the scene of video content, displaying a three-dimensional simulation of the background for the scene of video content, including the three-dimensional model and visual effects for the object, modifying the three-dimensional simulation of the background for the scene of video content based on user feedback, capturing video footage of a live action subject appearing together with the background for the scene of video content, where the live action subject appearing together with the background for the scene of video content creates the scene of video content, and saving the scene of video content.

In another example, a device includes a processing system including at least one processor and a computer-readable medium storing instructions which, when executed by the processing system, cause the processing system to perform operations. The operations include identifying a background for a scene of video content, generating a three-dimensional model and visual effects for an object appearing in the background for the scene of video content, displaying a three-dimensional simulation of the background for the scene of video content, including the three-dimensional model and visual effects for the object, modifying the three-dimensional simulation of the background for the scene of video content based on user feedback, capturing video footage of a live action subject appearing together with the background for the scene of video content, where the live action subject appearing together with the background for the scene of video content creates the scene of video content, and saving the scene of video content.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The teachings of the present disclosure can be readily understood by considering the following detailed description in conjunction with the accompanying drawings, in which:

FIG. 1 illustrates an example system in which examples of the present disclosure may operate;

FIG. 2 illustrates a flowchart of an example method for building virtual production sets for video content creation, immersive content in accordance with the present disclosure; and

FIG. 3 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure provides devices, non-transitory computer-readable media, and methods for building virtual production sets for video content creation. As discussed above, one virtual production method for creating video content comprises mixed reality (MR) with light emitting diodes (LEDs). MR with LEDs allows content creators to place real world characters and objects in a virtual environment, by integrating live action video production with a virtual background projected on a wall of LEDs. The virtual background images then move relative to the tracked camera to present the illusion of a realistic scene.

While MR with LEDs is in use by many major production companies, it is still a challenge to create realistic virtual backgrounds and to edit the backgrounds to match a content creator’s vision. For instance, the creation of real-time background scene creation is often delegated to a team of computer graphics designers and/or three-dimensional (3D) modeling artists. However, modern advances in computer vision and neural or generative techniques may improve the workflow for these designers and artists and reduce the burden of production.

A related issue is the editing and refinement of 3D objects to more precisely fit the actions required in a scene. For instance, in a highly dynamic and/or motion-intense scene, the animation of a 3D object may need to span a large virtual space (e.g., ten miles of a city during a car chase scene). In another example, background content may require emotional or object-based adaptations (e.g., make a public monument look more or less crowded, or rainy during a science fiction thriller). Neural and generative methods such as those discussed above may be able to facilitate dynamic modification of background content (e.g., by spoken or gesture-based editing of the objects, and without requiring specialized training).

In addition, it is challenging to integrate virtual background content with live/real world foreground action and physical environment elements in a manner that produced realistic results on camera. Instead of relying on a secondary crew to design lighting and sets for foreground interactions, neural and generative techniques may be used to push suggestions or control signals to lighting elements, object movements, or virtual “barriers” that prevent some camera motion to emulate a live scene.

Examples of the present disclosure provide a system that facilitates machine-guided creation of a virtual video production set, including the creation of backgrounds, lighting, and certain objects to the final filming and creation of video assets. The system may allow even novice content creators to produce high quality video assets. In some examples, background content may be created ad hoc from historical examples and/or spoken commands. Thus, rather than relying on graphic artists and specialists to create the background content, creation of the scene may be fueled by more natural gestures and dialogue.

In further examples, the system may allow interactive modification of the virtual video production set by utilizing the context of the on-set character movements (e.g., whether the characters appear worried, are moving quickly, are shouting, etc.). Generation of the background content in this case may involve tracking and aligning temporal events such that rendering views (corresponding to camera movements) may change and that in-place lighting and other optical effects can be automated.

In a further example, the system may push suggestions from background content correction to the foreground and special effects. For instance, the virtual background content may push or emphasize lighting changes and emphasis on foreground objects (e.g., if high glare or reflection is detected from an object in the background, the system may control on-set lighting to create a similar effect). In another example, neural rendering techniques (e.g., “deep fake” or other computer vision approaches for post-production tow-dimensional video modification) could be used to adjust the foreground based on the background environment and/or conditions.

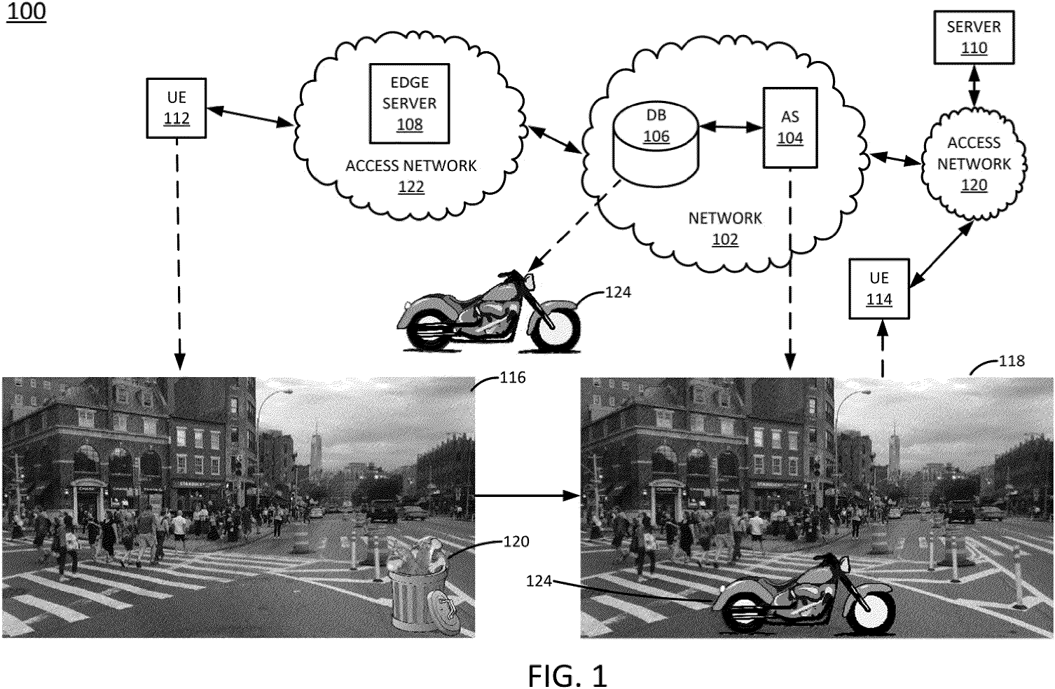

Examples of the present disclosure may thus create a virtual production set for display on a display system or device, such as a wall of LEDs. In further examples, the display may comprise a smaller or less specialized display, such as the screen of a mobile phone. Thus, even users lacking access to more professional-grade equipment may be able to produce professional quality video content (e.g., by displaying a virtual production set on the in-camera display of a mobile phone screen and generating a final video by direct screen recording). These and other aspects of the present disclosure are described in greater detail below in connection with the examples of FIGS. 1-3.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, 5G and the like related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102, e.g., a telecommunication service provider network, a core network, or an enterprise network comprising infrastructure for computing and communications services of a business, an educational institution, a governmental service, or other enterprises. The network 102 may be in communication with one or more access networks 120 and 122, and the Internet (not shown). In one example, network 102 may combine core network components of a cellular network with components of a triple play service network; where triple-play services include telephone services, Internet or data services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over internet Protocol (VoIP) telephony services. Network 102 may further comprise a broadcast television network, e.g., a traditional cable provider network or an internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/ video on demand (VoD) server, and so forth.

In one example, the access networks 120 and 122 may comprise broadband optical and/or cable access networks, Local Area Networks (LANs), wireless access networks (e.g., an IEEE 802.11/Wi-Fi network and the like), cellular access networks, Digital Subscriber Line (DSL) networks, public switched telephone network (PSTN) access networks, 3^{rd} party networks, and the like. For example, the operator of network 102 may provide a cable television service, an IPTV service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental or educational institution LANs, and the like.

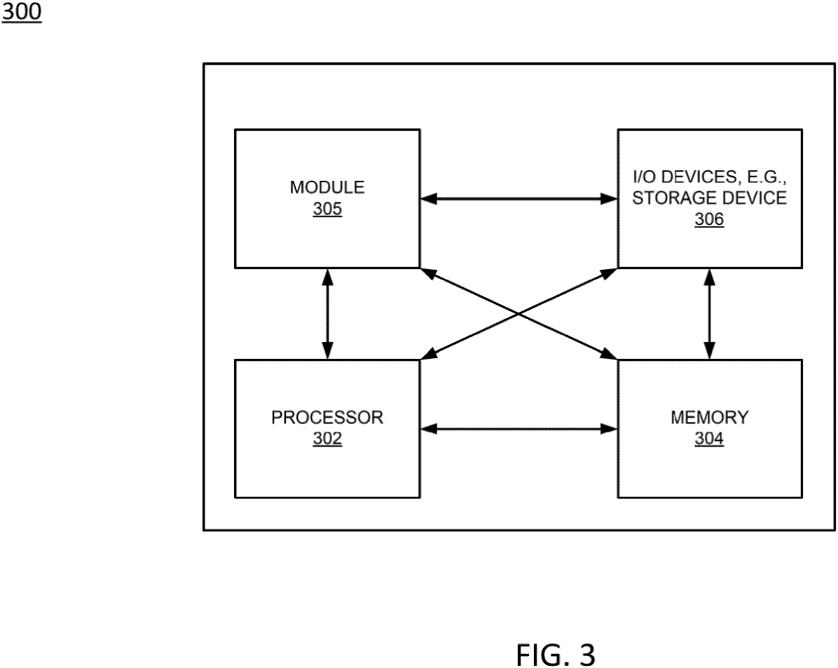

In accordance with the present disclosure, network 102 may include an application server (AS) 104, which may comprise a computing system or server, such as computing system 300 depicted in FIG. 3, and may be configured to provide one or more operations or functions in connection with examples of the present disclosure for building virtual production sets for video content creation. The network 102 may also include a database (DB) 106 that is communicatively coupled to the AS 104. The database 106 may contain scenes of video content, virtual backgrounds, three-dimensional models of objects, and other elements which may be used (and reused) in the creation of video content. Additionally, the database 106 may store profiles for users of the application(s) hosted by the AS 104. Each user profile may include a set of data for an individual user. The set of data for a given user may include, for example, pointers (e.g., uniform resource locators, file locations, etc.) to scenes of video content created by or accessible to the given user, pointers to background scenes provided by or accessible to the given user, pointers to three-dimensional objects created by or accessible to the given user, and/or other data.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure. Thus, although only a single application server (AS) 104 and single database (DB) are illustrated, it should be noted that any number of servers may be deployed, and which may operate in a distributed and/or coordinated manner as a processing system to perform operations in connection with the present disclosure.

In one example, AS 104 may comprise a centralized network-based server for building virtual production sets for video content creation. For instance, the AS 104 may host an application that assists users in building virtual production sets for video content creation. In one example, the AS 104 may be configured to build a virtual, three-dimensional background image that may be displayed on a display (e.g., a wall of LEDs, a screen of a mobile phone, or the like) based on a series of user inputs. Live action objects and actors may be filmed in front of the virtual, three-dimensional background image in order to generate a scene of video content.

For instance, the AS 104 may generate an initial background image based on an identification of a desired background by a user. The background image may be generated based on an image provided by the user, or based on some other input (e.g., spoken, text, gestural, or the like) from the user which may be interpreted by the AS 104 as identifying a specific background or location. Furthermore, the AS 104 may break the initial background image apart into individual objects, and may subsequently generate three-dimensional models for at least some of the objects appearing in order to enhance the realism and immersion of the virtual production set.

In further examples, the AS 104 may adapt the initial background image based on further user inputs. For instance, the AS 104 may add new objects, remove existing objects, move existing objects, change lighting effects, add, remove, or enhance environmental or mood effects, and the like. As an example, the user may specify a style for a scene of video content, such as “film noir.” The AS 104 may then determine the appropriate color and/or brightness levels of individual LEDs of an LED wall (or pixels of a display device, such as a mobile phone screen) to produce the high contrast lighting effects, to add rain or fog, or the like.

In one example, AS 104 may comprise a physical storage device (e.g., a database server) to store scenes of video content, background images, three-dimensional models of objects, completed virtual production sets, and/or user profiles. In one example, the DB 106 may store the scenes of video content, background images, three-dimensional models of objects, completed virtual production sets, and/or user profiles, and the AS 104 may retrieve scenes of video content, background images, three-dimensional models of objects, completed virtual production sets, and/or user profiles from the DB 106 when needed. For ease of illustration, various additional elements of network 102 are omitted from FIG. 1.

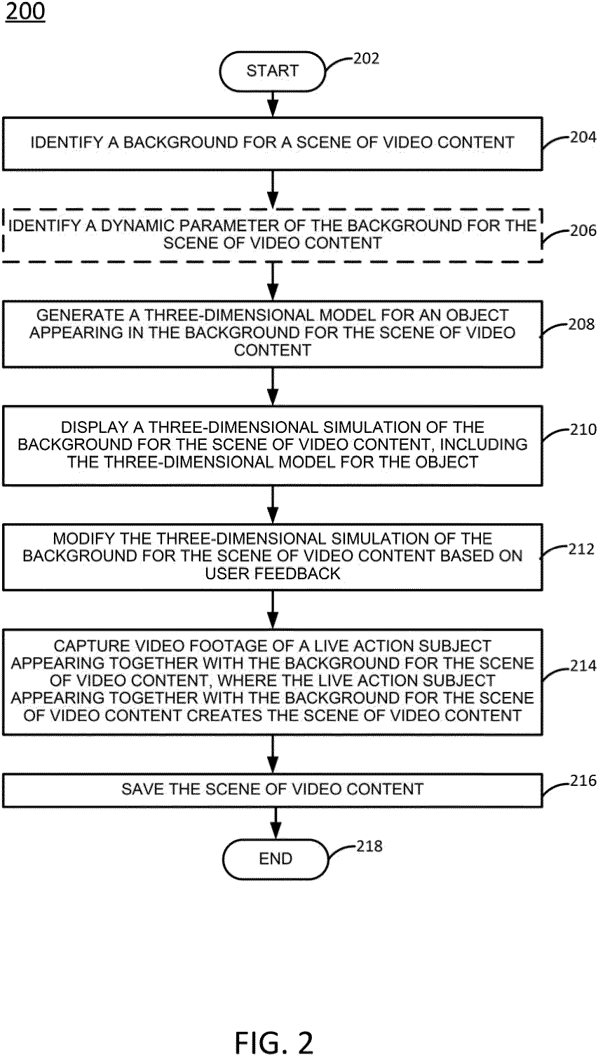

In one example, access network 122 may include an edge server 108, which may comprise a computing system or server, such as computing system 300 depicted in FIG. 3, and may be configured to provide one or more operations or functions for building virtual production sets for video content creation, as described herein. For instance, an example method 200 for building virtual production sets for video content creation is illustrated in FIG. 2 and described in greater detail below.

In one example, application server 104 may comprise a network function virtualization infrastructure (NFVI), e.g., one or more devices or servers that are available as host devices to host virtual machines (VMs), containers, or the like comprising virtual network functions (VNFs). In other words, at least a portion of the network 102 may incorporate software-defined network (SDN) components. Similarly, in one example, access networks 120 and 122 may comprise “edge clouds,” which may include a plurality of nodes/host devices, e.g., computing resources comprising processors, e.g., central processing units (CPUs), graphics processing units (GPUs), programmable logic devices (PLDs), such as field programmable gate arrays (FPGAs), or the like, memory, storage, and so forth. In an example where the access network 122 comprises radio access networks, the nodes and other components of the access network 122 may be referred to as a mobile edge infrastructure. As just one example, edge server 108 may be instantiated on one or more servers hosting virtualization platforms for managing one or more virtual machines (VMs), containers, microservices, or the like. In other words, in one example, edge server 108 may comprise a VM, a container, or the like.

In one example, the access network 120 may be in communication with a server 110 and a user endpoint (UE) device 114. Similarly, access network 122 may be in communication with one or more devices, e.g., a user endpoint device 112. Access networks 120 and 122 may transmit and receive communications between server 110, user endpoint devices 112 and 114, application server (AS) 104, other components of network 102, devices reachable via the Internet in general, and so forth. In one example, the user endpoint devices 112 and 114 may comprise desk top computers, laptop computers, tablet computers, mobile devices, cellular smart phones, wearable computing devices (e.g., smart glasses, virtual reality (VR) headsets or other types of head mounted displays, or the like), or the like. In one example, at least one of the user endpoint devices 112 and 114 may comprise a light emitting diode display (e.g., a wall of LEDs for displaying virtual backgrounds). In one example, at least some of the user endpoint devices 112 and 114 may comprise a computing system or device, such as computing system 300 depicted in FIG. 3, and may be configured to provide one or more operations or functions in connection with examples of the present disclosure for building virtual production sets for video content creation.

In one example, server 110 may comprise a network-based server for building virtual production sets for video content creation. In this regard, server 110 may comprise the same or similar components as those of AS 104 and may provide the same or similar functions. Thus, any examples described herein with respect to AS 104 may similarly apply to server 110, and vice versa. In particular, server 110 may be a component of a video production system operated by an entity that is not a telecommunications network operator. For instance, a provider of a video production system may operate server 110 and may also operate edge server 108 in accordance with an arrangement with a telecommunication service provider offering edge computing resources to third-parties. However, in another example, a telecommunication network service provider may operate network 102 and access network 122, and may also provide a video production system via AS 104 and edge server 108. For instance, in such an example, the video production system may comprise an additional service that may be offered to subscribers, e.g., in addition to network access services, telephony services, traditional television services, and so forth.

In an illustrative example, a video production system may be provided via AS 104 and edge server 108. In one example, a user may engage an application via a user endpoint device 112 or 114 to establish one or more sessions with the video production system, e.g., a connection to edge server 108 (or a connection to edge server 108 and a connection to AS 104). In one example, the access network 122 may comprise a cellular network (e.g., a 4G network and/or an LTE network, or a portion thereof, such as an evolved Uniform Terrestrial Radio Access Network (eUTRAN), an evolved packet core (EPC) network, etc., a 5G network, etc.). Thus, the communications between user endpoint device 112 or 14 and edge server 108 may involve cellular communication via one or more base stations (e.g., eNodeBs, gNBs, or the like). However, in another example, the communications may alternatively or additional be via a non-cellular wireless communication modality, such as IEEE 802.11/Wi-Fi, or the like. For instance, access network 122 may comprise a wireless local area network (WLAN) containing at least one wireless access point (AP), e.g., a wireless router. Alternatively, or in addition, user endpoint device 112 or 114 may communicate with access network 122, network 102, the Internet in general, etc., via a WLAN that interfaces with access network 122.

In the example of FIG. 1, user endpoint device 112 may establish a session with edge server 108 for accessing a video production system. As discussed above, the video production system may be configured to generate a virtual background for a scene of video content, where the virtual background may be displayed on a display (e.g., a wall of LEDs, a mobile phone screen, or the like) that serves as a background in front of which live action actors and/or objects may be filmed. The video production system may guide a user who is operating the user endpoint device 112 through creation of the virtual background by prompting the user for inputs, where the inputs may include images, text, gestures, spoken utterances, selections from a menu of options, and other types of inputs.

As an example, the user may provide to the AS 104 an image 116 upon which a desired background scene is to be based. The image 116 may comprise a single still image or a series of video images. In the example depicted in FIG. 1, the image 116 comprises a still image of a city street. The image 116 may comprise an image that is stored on the user endpoint device 112, an image that the user endpoint device 112 retrieved from an external source (e.g., via the Internet), or the like. In another example, the user may verbally indicate the desired background scene. For instance, the user may say “New York City.” The AS 104 may recognize the string “New York City,” and may use all or some of the string as a search term to search the DB 104 (or another data source) for images matching the string. For instance, the AS 104 may search for background images whose metadata tags indicate a location of “New York City,” “New York,” “city,” synonyms for any of the foregoing (e.g., “Manhattan,” “The Big Apple,” etc.), or the like.

Based on the image 116, the AS 104 may generate a background image 118. The background image 118 may include three-dimensional models for one or more objects that the AS 104 detects in the image, such as buildings, cars, street signs, pedestrians, and the like. In some examples, the user may provide further inputs for modifying the background image 118, where the further inputs may be provided in image, text, gestural, spoken, or other forms. For instance, the user may verbally indicate that a three-dimensional model of a trash can 120 appearing in the image 116 be removed from the background image 118. In response, the AS 104 may remove the three-dimensional model of a trash can 120 from the background image 118, as illustrated in FIG. 1. The user may also or alternatively request that three-dimensional models for objects that did not appear in the image 116 be inserted into the background image 118. For instance, the user may indicate by selecting a model from a menu of options that they would like a three-dimensional model 124 of a motorcycle to be inserted front and center in the background image 118. In response, the AS 104 may insert a three-dimensional model 124 of a motorcycle front and center in the background image 118, as illustrated in FIG. 1. The user may also specify changes to lighting, environmental effects, style or mood effects, intended interactions of live action actors with the background image 118 (or objects appearing therein). In response, the AS 104 may modify the background image 118 to accommodate the user’s specifications. The final background image 118 may be sent to a user endpoint device 114, which may comprise a device that is configured to display the background image for filming of video content. For instance, the device may comprise a wall of LEDs or a mobile phone screen in front of which one or more live action actors or objects may be filmed.

It should also be noted that the system 100 has been simplified. Thus, it should be noted that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102, access networks 120 and 122, and/or Internet may comprise a content distribution network (CDN) having ingest servers, edge servers, and the like for packet-based streaming of video, audio, or other content. Similarly, although only two access networks, 120 and 122 are shown, in other examples, access networks 120 and/or 122 may each comprise a plurality of different access networks that may interface with network 102 independently or in a chained manner. In addition, as described above, the functions of AS 104 may be similarly provided by server 110, or may be provided by AS 104 in conjunction with server 110. For instance, AS 104 and server 110 may be configured in a load balancing arrangement, or may be configured to provide for backups or redundancies with respect to each other, and so forth. Thus, these and other modifications are all contemplated within the scope of the present disclosure.

To further aid in understanding the present disclosure, FIG. 2 illustrates a flowchart of a method 200 for building virtual production sets for video content creation in accordance with the present disclosure. In one example, the method 200 may be performed by an application server that is configured to generate virtual backgrounds, such as the AS 104 or server 110 illustrated in FIG. 1. However, in other examples, the method 200 may be performed by another device, such as the processor 302 of the system 300 illustrated in FIG. 3. For the sake of example, the method 200 is described as being performed by a processing system.

The method 200 begins in step 202. In step 204, the processing system may identify a background for a scene of video content. In one example, the background may be identified in accordance with a signal received from a user (e.g., a creator of the video content). The signal may be received in any one of a plurality of forms, including an image signal (e.g., a photo or video of the desired background, such as a New York City street), a spoken signal (e.g., a user uttering the phrase “New York City”), and text-based signal (e.g., a user typing the term “New York City”). In another example, the signal may comprise a user selection from a predefined list of potential backgrounds.

In one example, the processing system may analyze the signal in order to identify the desired background for the scene of video content. For instance, if the signal comprises a spoken signal, the processing system may utilize speech processing techniques including automatic speech recognition, natural language processing, semantic analysis, and/or the like in order to interpret the signal and identify the desired background (e.g., if the user says “Manhattan,” the processing system may recognize the word “Manhattan” as the equivalent of “New York City” or “New York, NY”). If the signal comprises a text-based signal, the processing system may utilize natural language processing, semantic analysis, and/or the like in order to interpret the signal and identify the desired background. If the signal comprises an image signal, the processing system may utilize object recognition, text recognition, character recognition, and/or the like in order to interpret the signal and identify the desired background (e.g., if the image includes an image of the Empire State Building, or a street sign for Astor Place, the processing system may recognize these items as known locations in New York City). Once the desired background is identified, the processing system may retrieve an image (e.g., a two-dimensional image) of the desired background, for instance by querying a database or other data sources.

In optional step 206 (illustrated in phantom), the processing system may identify a dynamic parameter of the background for the scene of video content. In one example, the dynamic parameter may be identified in accordance with a signal from the user. In one example, the dynamic parameter may comprise a desired interaction of the background with foreground objects or characters (e.g., real world or live action objects or characters that are to appear in the scene of video content along with the background). For instance, the dynamic parameter may comprise an action of the foreground objects or characters while the background is visible (e.g., characters running, fighting, or talking, cars driving fast, etc.). In a further example, the dynamic parameter may also include any special effects to be applied to the scene, such as lighting effects (e.g., glare, blur, etc.), motion effects (e.g., slow motion, speed up, etc.), and the like.

In step 208, the processing system may generate a three-dimensional model for an object appearing in the background for the scene of video content (optionally accounting for a dynamic parameter of the background, if identified). For instance, in one example, the background identified in step 204 may comprise only a two-dimensional background image; however, for the purposes of creating the scene of video content, a three-dimensional background may be desirable to enhance realism. In one example, the processing system may break the background for the scene of video content apart into individual objects (e.g., buildings, cars, trees, etc.). These individual objects may each be separately modeled as three-dimensional objects.

In one example, breaking the background for the scene of video content apart into individual objects may include receiving user input regarding object and character actions. For instance, the user may indicate whether a person is depicted walking, a car is depicted driving, a bird is depicted flying, or the like in the background for the scene of video content. Information regarding object and character actions may assist the processing system in determining the true separation between the background and the foreground in the background identified in step 204 (e.g., in some cases, the object and character actions are more likely to be occurring in the foreground).

In one example, three-dimensional modeling of objects depicted in the background for the scene of video content may make use of preexisting three-dimensional assets that are already present in the background for the scene of video content. For instance, in one example, the background for the scene of video content may comprise one or more frames of volumetric video in which objects may already be rendered in three dimensions.

In one example, three-dimensional modeling of objects depicted in the background for the scene of video content may involve using a generative adversarial network (GAN) to generate a rough separation of background and foreground from the background for the scene of video content. In some examples, if a visual similarity between an object depicted in the background for the scene of video content and an existing three-dimensional model for a similar object is strong enough (e.g., exhibits at least a threshold similarity), then the existing three-dimensional model may be substituted for object depicted in the background for the scene of video content. For instance, if the background for the scene of video content depicts a 1964 metallic mint green Buick Skylark™ convertible, and the processing system has access to a three-dimensional model for a 1963 metallic mint green Pontiac Tempest™ convertible, the visual similarities between the two cars may be determined to meet a sufficient threshold such that the three-dimensional model for the Pontiac Tempest can be utilized, rather than generating a new three-dimensional model for the Buick Skylark.

In further examples, the processing system may add an existing three-dimensional model for an object, where the object was not depicted in the original background for the scene of video content. For instance, in order to make the background for the scene of video content appear more active or interesting, the processing system may add objects such as people walking, trees swaying in the wind, or the like. In one example, any added objects are determined to be contextually appropriate for the background for the scene of video content. For instance, if the background for the scene of video content depicts a street in New York City, the processing system would not add a three-dimensional model of a palm tree swaying in the wind. The processing system might, however, add a three-dimensional model of a hot dog cart.

In one example, any three-dimensional models that are generated in step 208 may be saved to a database for later review and/or tuning, e.g., by a professional graphic artist. This may allow newly generated three-dimensional models to be vetted, improved, and made available for later reuse by the user and/or others.

In another example, generating the three-dimensional model for the object may further comprise generating visual effects for the object. While a three-dimensional model may represent a real-world object having a well-defined shape, visual effects may represent characteristics of the real-world object that are more ephemeral or are not necessarily well-defined in shape. For instance, visual effects may be rendered to represent fluids, volumes, water, fire, rain, snow, smoke, or the like. As an example, a real-world object might comprise a block of ice. While a three-dimensional model for a block of ice may be retrieved to represent the shape of the block of ice, visual effects such as a puddle of melting water beneath the block of ice, water vapor evaporating from the block of ice, or the like may be added to enhance the realism of the three-dimensional model.

In step 210, the processing system may display a three-dimensional simulation of the background for the scene of video content, including the three-dimensional model for the object. The three-dimensional simulation of the background for the scene of video content may comprise, for instance, a proposed virtual background to be used during filming of the scene of video content. Thus, the three-dimensional simulation of the background for the scene of video content may comprise an image of the background as identified (e.g., a New York City Street) and one or more objects that have been modeled in three dimensions (e.g., buildings, trees, taxis, pedestrians, etc.). In one example, the three-dimensional simulation of the background for the scene of video content may be sent to display, such as a wall of LEDs or a mobile phone screen. In this case, the processing system may control the color and/or brightness levels of individual LEDs of the wall of LEDs or pixels of the mobile phone screen to create the three-dimensional simulation of the background for the scene of video content.

In a further example, the three-dimensional simulation of the background for the scene of video content may further comprise lighting effects to simulate the presence of on-set lighting. For instance, in place of physical lights on a set, portions of a wall of LEDs or pixels of a mobile phone screen could have their brightness levels and/or color adjusted to appear as if certain types of physical lights (e.g., key lighting, fill lighting, back lighting, side lighting, etc.) are providing light in certain locations and/or from certain directions.

In one example, the three-dimensional simulation of the background for the scene of video content may comprise one of a plurality of three-dimensional simulations of the background for the scene of video content, where the processing system may display each three-dimensional simulation of the plurality of three-dimensional simulations of the background for the scene of video content. For instance, the processing system may cycle through display of the plurality of three-dimensional simulations of the background for the scene of video content in response to user signals (e.g., the user may signal when they are ready to view a next three-dimensional simulation).

In step 212, the processing system may modify the three-dimensional simulation of the background for the scene of video content based on user feedback. For instance, on viewing the three-dimensional simulation of the background for the scene of video content, the user may elect to make one or more changes to the three-dimensional simulation of the background for the scene of video content. For instance, the user may select one of a plurality of three-dimensional simulations of the background for the scene of video content that are displayed.

Alternatively or in addition, the user may wish to make one or more modifications to the features and/or objects of a selected three-dimensional simulation. For instance, the user may wish to adjust the color of an object, the size of an object, or another physical aspect of an object. As an example, the user may wish to change text on a street sign for which a three-dimensional model has been generated, or to remove graffiti from the side of a building for which a three-dimensional model has been generated. Similarly, the user may wish to add or remove a certain object or to replace a certain object with a different object. As an example, the user may wish to remove a trash can for which a three-dimensional model has been generated, or to replace a car for which a three-dimensional model has been generated with a different type of car. The user may also wish to adjust the lighting and/or environmental conditions of the three-dimensional simulation of the background for the scene of video content. As an example, the user may wish to make the scenery appear more or less rainy, as the scenery would appear at a different time of day or during a different season, or the like. The style of the three-dimensional simulation of the background for the scene of video content could also be changed to reflect a desired style (e.g., film noir, documentary, art house, etc.).

In one example, the processing system may receive a signal including user feedback indicating one or more modifications to be made to the three-dimensional simulation of the background for the scene of video content. For instance, if the user searches for how to change a particular feature or object (e.g., “how to make the scene less rainy” or “how to remove a car from a scene”), this may indicate that the user wishes to change the particular feature or object. In another example, when displaying the three-dimensional simulation of the background for the scene of video content, the processing system may provide an indication as to which features or objects may be modified. For instance, the display may include a visual indicator to designate features and objects that can be modified (e.g., a highlighted border around an object indicates that the object can be modified). When the user interacts with the visual indicator (e.g., clicking on, hovering over, or touching the screen of a display), this may indicate that the user wishes to modify the indicated feature or object. In another example, the user may provide an image as an example of the modification they would like to make (e.g., a still of a scene from a film noir movie to show how to modify the style of the three-dimensional simulation of the background for the scene of video content).

In another example, the user feedback may comprise a spoken signal or action that is tracked by the processing system (e.g., utilizing one or more cameras). For instance, the user may rehearse the scene of video content in front of the three-dimensional simulation of the background for the scene of video content, and the processing system may track the user’s movements during the rehearsal to determine appropriate modifications to make to lighting, scenery, and the like. As an example, if the user moves in front of a portion of the three-dimensional simulation of the background for the scene of video content that is lit brightly, the user may appear to be washed out; thus, the processing system may determine that the lighting in at least that portion of the three-dimensional simulation of the background for the scene of video content should be dimmed. Similarly, if the user moves beyond a boundary of the three-dimensional simulation of the background for the scene of video content, the processing system may determine that the boundaries of the three-dimensional simulation of the background for the scene of video content should be extended.

Spoken utterances and/or gestures made by the user during the rehearsal may also provide feedback on which modifications to the three-dimensional simulation of the background for the scene of video content can be based. For instance, the user may verbalize the idea that a particular object should be placed in a particular location in the three-dimensional simulation of the background for the scene of video content, or that a particular object that is already depicted in the three-dimensional simulation of the background for the scene of video content should be removed (e.g., “Maybe we should remove this trash can”). Alternatively or in addition, the user may gesture to an object or a location within the background for the scene of video content to indicate addition or removal (e.g., pointing and saying “Add a street sign here”).

In one example, any modifications made in step 212 to the three-dimensional simulation of the background for the scene of video content may involve modifying the color and/or brightness levels of individual LEDs of a wall of LEDs or pixels of a display (e.g., mobile phone or tablet screen or the like) on which the three-dimensional simulation of the background for the scene of video content is displayed. The modifications to the color and/or brightness levels may result in the appearance that objects and/or effects have been added, removed, or modified.

In step 214, the processing system may capture video footage of a live action subject appearing together with the background for the scene of video content (which may have optionally been modified in response to user feedback prior to video capture), where the live action subject appearing together with the background for the scene of video content creates the scene of video content. For instance, the processing system may be coupled to one or more cameras that are controllable by the processing system to capture video footage.

In one example, capture of the video footage may include insertion of data into the video footage to aid in post-production processing of the video footage. For instance, the processing system may embed a fiducial (e.g., a machine-readable code such as a bar code, a quick response (QR) code, or the like) into one or more frames of the video footage, where the fiducial is encoded with information regarding the addition of special effects or other post-production effects into the video footage. For instance, the fiducial may specify what types of effects to add, when to add the effects (e.g., which frames or time stamps), and where (e.g., locations within the frames, such as upper right corner). In another example, the processing system may insert a visual indicator to indicate an object depicted in the video footage that requires post-production processing. For instance, the processing system may highlight or insert a border around the object requiring post-production processing, may highlight a predicted shadow to be cast by the object, or the like.

In step 216, the processing system may save the scene of video content. For instance, the scene of video content may be saved to a profile or account associated with the user, so that the user may access the scene of video content to perform post-production processing, to share the scene of video content, or the like. In a further example, the processing system may also store the scene of video content, or elements of the scene of video content, such as three-dimensional models of objects appearing in the scene of video content, settings for lighting or environmental effects, and the like, to a repository that is accessible by multiple users. The repository may allow users to view scenes of video content created by other users as well as to reuse elements of those videos scenes of video content (e.g., three-dimensional models of objects, lighting and environmental effects, etc.) in the creation of new scenes of video content.

The method 200 may end in step 218.

Thus, examples of the present disclosure may provide a “virtual” production set by which even users who possess little to no expertise in video production can produce professional quality scenes of video content by leveraging mixed reality with LEDs technology. Examples of the present disclosure may be used to create virtual background environments which users can immerse in, modify, and interact with for gaming, making video content, and other applications. This democratizes the scene creation process for users. For instance, in the simplest user case, a user need only provide some visual examples for initial scene creation. The processing system may then infer the proper background and dynamics from the integration of actors and/or objects. As such, the scene need not be created “from scratch.” Moreover, the ability to control integration and modification of objects based on spoken or gestural signals provides for intuitive customization of a scene.

Examples of the present disclosure may also be used to facilitate the production of professionally produced content. For instance, examples of the present disclosure may be used to create virtual background environments for box office films, television shows, live performances (e.g., speeches, virtual conference presentations, talk shows, news broadcasts, award shows, and the like). Tight integration of lighting control may allow the processing system to match the lighting to the style or mood of a scene more quickly than is possible by conventional, human-driven approaches. Moreover, post-production processing and costs may be minimized by leveraging knowledge of any necessary scene effects at the time of filming. In further examples, background scenes may be created with “placeholders” into which live video footage (e.g., a news broadcast) may be later inserted.

Moreover, examples of the present disclosure may enable the creation and continuous augmentation of a library of shareable, sellable, or reusable content, including background environments, three-dimensional models of objects, lighting and environmental effects, and the like, where this content can be used and/or modified in the production of any type of video content.

In further examples, examples of the present disclosure may be deployed for use with deformable walls of LEDs. That is, the walls into which the LEDs are integrated may have deformable shapes which allow for further customization of backgrounds (e.g., approximation of three-dimensional structures).

In further examples, rather than utilizing a wall of LEDs, examples of the present disclosure may be integrated with projection systems to place visuals of objects and/or actors in a scene or primary camera action zone.

In further examples, multiple scenes of video content created in accordance with the present disclosure may be layered to provide more complex scenes. For instance, an outdoor scene may be created as a background object, and an indoor scene may be created as a foreground object. The foreground object may then be layered on top of the background object to create the sensation of being indoors, but having the outdoors in sight (e.g., through a window).

In further examples, techniques such as neural radiance fields (NeRF) and other three-dimensional inference methods may be leveraged to derive scenes from a user’s personal media (e.g., vacation videos, performances, etc.). For instance, a virtual production set could be created to mimic the setting of the personal media.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 3 depicts a high-level block diagram of a computing device specifically programmed to perform the functions described herein. For example, any one or more components or devices illustrated in FIG. 1 or described in connection with the method 200 may be implemented as the system 300. For instance, a server (such as might be used to perform the method 200) could be implemented as illustrated in FIG. 3.

As depicted in FIG. 3, the system 300 comprises a hardware processor element 302, a memory 304, a module 305 for building virtual production sets for video content creation, and various input/output (I/O) devices 306.

The hardware processor 302 may comprise, for example, a microprocessor, a central processing unit (CPU), or the like. The memory 304 may comprise, for example, random access memory (RAM), read only memory (ROM), a disk drive, an optical drive, a magnetic drive, and/or a Universal Serial Bus (USB) drive. The module 305 for building virtual production sets for video content creation may include circuitry and/or logic for performing special purpose functions relating to the operation of a home gateway or XR server. The input/output devices 306 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for building virtual production sets for video content creation (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for building virtual production sets for video content creation (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
identifying, by a processing system including at least one processor, a background for a scene of video content;
generating, by the processing system, a three-dimensional model and visual effects for an object appearing in the background for the scene of video content;
displaying, by the processing system, a three-dimensional simulation of the background for the scene of video content, including the three-dimensional model and visual effects for the object;
modifying, by the processing system, the three-dimensional simulation of the background for the scene of video content based on user feedback;
capturing, by the processing system, video footage of a live action subject appearing together with the background for the scene of video content, where the live action subject appearing together with the background for the scene of video content creates the scene of video content; and
saving, by the processing system, the scene of video content.

2. The method of claim 1, wherein the background for the scene of video content is identified in accordance with a signal received from a user, wherein the signal comprises at least one of: an image signal, a spoken signal, a text-based signal, or a user selection from a predefined list of potential backgrounds.

3. The method of claim 1, wherein the generating comprises breaking the background for the scene of video content apart into a plurality of individual objects including the object, and separately modeling the plurality of individual objects as three-dimensional objects.

4. The method of claim 1, wherein the generating comprises determining a separation between a background and a foreground in the background for the scene of video content based on information provided by a user regarding object and character actions in the scene of video content.

5. The method of claim 1, wherein the generating reuses an existing three-dimensional model for another object that shares a threshold similarity with the object.

6. The method of claim 1, wherein the object comprises an object that is not present in an input image for the background for the scene of video content, but that the processing system determines to be relevant to the background for the scene of video content based on context.

7. The method of claim 1, wherein the three-dimensional model and visual effects for the object are saved for later reuse in another scene of video content.

8. The method of claim 1, wherein the three-dimensional simulation of the background for the scene of video content is displayed on a wall of light emitting diodes.

9. The method of claim 8, wherein the modifying comprises adjusting a color and a brightness of at least one light emitting diode of the wall of light emitting diodes in order to modify an appearance of the three-dimensional simulation of the background for the scene of video content.

10. The method of claim 9, wherein the modifying comprises adding to the three-dimensional simulation of the background for the scene of video content a three-dimensional model and visual effects for a new object that is not initially present in the three-dimensional simulation of the background for the scene of video content.

11. The method of claim 9, wherein the modifying comprises removing from the three-dimensional simulation of the background for the scene of video content a three-dimensional model and visual effects for an unwanted object that is initially present in the three-dimensional simulation of the background for the scene of video content.

12. The method of claim 9, wherein the modifying comprises modifying an appearance of the object as displayed in three-dimensional simulation of the background for the scene of video content.

13. The method of claim 9, wherein the modifying comprises modifying a lighting effect in the three-dimensional simulation of the background for the scene of video content.

14. The method of claim 9, wherein the modifying comprises modifying an environmental effect in the three-dimensional simulation of the background for the scene of video content.

15. The method of claim 9, wherein the modifying comprises modifying the three-dimensional simulation of the background for the scene of video content to emulate at least one of: a user-defined visual style or a user-defined mood.

16. The method of claim 1, wherein the modifying further comprises modifying a foreground to account for an effect generated by an object in the background for the scene of video content.

17. The method of claim 1, further comprising:
identifying, by the processing system, a dynamic parameter of the background for the scene of video content.

18. The method of claim 17, wherein the dynamic parameter comprises an interaction of the live action subject with the object, and wherein the generating accounts for the interaction.

19. A non-transitory computer-readable medium storing instructions which, when executed by a processing system including at least one processor, cause the processing system to perform operations, the operations comprising:
identifying a background for a scene of video content;
generating a three-dimensional model and visual effects for an object appearing in the background for the scene of video content;
displaying a three-dimensional simulation of the background for the scene of video content, including the three-dimensional model and visual effects for the object;
modifying the three-dimensional simulation of the background for the scene of video content based on user feedback;
capturing video footage of a live action subject appearing together with the background for the scene of video content, where the live action subject appearing together with the background for the scene of video content creates the scene of video content; and
saving the scene of video content.

20. A device comprising:
a processing system including at least one processor; and
a computer-readable medium storing instructions which, when executed by the processing system, cause the processing system to perform operations, the operations comprising:
identifying a background for a scene of video content;
generating a three-dimensional model and visual effects for an object appearing in the background for the scene of video content;
displaying a three-dimensional simulation of the background for the scene of video content, including the three-dimensional model and visual effects for the object;
modifying the three-dimensional simulation of the background for the scene of video content based on user feedback;
capturing video footage of a live action subject appearing together with the background for the scene of video content, where the live action subject appearing together with the background for the scene of video content creates the scene of video content; and
saving the scene of video content.
